(19) United States
(12) Patent Application Publication
(10) Pub. No.: US 2005/0019520 A1
(43) Pub. Date: Jan. 27, 2005

(54) Triangle shaped labels and improved configuration process

(75) Inventors: Andrew B. Milliorn, Kennedale, TX (US); J. Michael Milliorn, Fort Worth, TX (US)

Correspondence Address: ECOLAB INC., 840 SIBLEY MEMORIAL HIGHWAY, MENDOTA HEIGHTS, MN, 55118, US

(73) Assignee: DAYDOTS INTERNATIONAL, INC.

(21) Appl. No.: 10/799,319

(22) Filed: Mar. 12, 2004

Related U.S. Application Data
(62) Division of application No. 09/912,621, filed on Jul. 24, 2001.

(51) Int. Cl. B32B 9/00

(52) U.S. Cl. 428/42.3; 428/40.1

(57) ABSTRACT

An adhesive label is produced by a process that includes the steps of providing a web consisting of an adhesive label substrate having a face material, an adhesive layer and a liner. The web is positioned in a label conversion machine wherein the web is continuously pulled through the conversion machine in a preselected web direction. A plurality of triangular shaped labels are configured on the face material in which each label has a first, second and third side wherein the first side of adjacent labels face each other and the second side of adjacent labels face each other such that the third side of each label faces outwardly from the web width. The labels are cut on the web and then printed. The labels are then further processed into individual rolled strips.

### PRIORITY INFORMATION

The present application is a division of claims priority to U.S. patent application Ser. No. 09/912,621, filed Jul. 24, 2001.

### FIELD OF THE INVENTION

The present invention relates to adhesive labels and more particularly to triangular shaped adhesive labels and a configuration process for creating the triangular shaped labels for use in food safety labeling systems.

### BACKGROUND OF THE INVENTION

Existing labels range in size and shape, and have specific adhesives and face materials for very specific purposes. For example, food safety is a major concern for restaurants and other establishments involved in the storage and preparation of food for human consumption (the food services industry). To ensure such food safety, the food services industry applies adhesive labels to the surface of containers holding food to inform the food handler as to the types of food and its date of preparation and/or date of possible spoilage or non-use. These labels are used as part of food safety labeling systems and there are numerous variations of food safety labeling systems currently on the market. Presently the label shapes most commonly used in food safety labeling systems are circles, squares, and rectangles.

There are three main types of labels used in these food safety labeling systems—day of the week FIFO (first in first out) systems, shelf-life/product identification labels and use by/use first labeling. Food safety labeling systems also use an industry standard color code system of blue for Monday, yellow for Tuesday, red for Wednesday, brown for Thursday, green for Friday, orange for Saturday, and black for Sunday on the labels. These colors are used to quickly identify the days of the week on labels used in food safety labeling systems.

There are three main components used in the production of adhesive or pressure sensitive adhesive labels. The process, commonly referred to as “converting,” requires a pressure sensitive or adhesive substrate, and converting machinery that includes a cutting die or other cutting means. An additional aspect of adhesive or pressure sensitive label converting is printing on the formed label. This is done using printing inks and plates during the converting process.

A pressure sensitive or adhesive substrate is a construction of three elements: face material, adhesive, and liner. The substrate is generally produced by and purchased from a specialty supplier of adhesive materials. The face material is the visible part of the label. It is the top layer in the construction of the substrate and is the surface to which the printing ink is applied. The face material is most commonly paper, but can also be polyester, vinyl, polypropylene or even foil. The type of face material selected for a label is determined by the intended use of the label and the desired quality of the printing. The adhesive is the part of the label that makes it stick and it is coated to the under surface of the face material while the substrate is being produced. There are several types of adhesives applicable for various applications. Examples include permanent, removable, water-soluble, and cold temperature adhesives. The liner is a silicone-coated sheet of paper that allows the face material and applied adhesive to be easily removed for application on other surfaces. The adhesive substrate is usually supplied in rolls and during the converting process, the substrate is referred to as the “web.”

The cutting die is a precision-machined rotary tool that cuts the substrate into shapes. The cutting die is made of steel and has sharpened blades that cut through the face material and adhesive, but does not cut into the liner. The die cuts the substrate as it passes through the cutting die location in the converting machinery. Cutting of the shapes into the substrate can also be performed by lasers.

After the shapes have been cut into the web, the waste area between the labels is pulled away. This waste area is called the “matrix.” Removal of the matrix leaves the individual label shapes on the liner to be wound back into a roll for further processing. Cutting dies and lasers can cut very simple shapes such as circles or squares, or very complex shapes depending on the application. The labels are then processed through the printing press portion of the converting machinery and the rolls of labels are further processed on a rewinder. The blades on the rewinder slits the web into individual strips, which are wound into small rolls of generally 500 to 1000 labels each. The small rolls are then packaged for shipping.

Adhesive labels are produced in a variety of shapes. When labels are produced in the shape of circles, squares and rectangles, there is a substantial amount of matrix or waste area left between the individual shapes after the cutting die has cut the shapes into the web. The size of this matrix results in a substantial amount of adhesive substrate being required for the production of rolls of circular, square and rectangular shaped labels.

It is customary to print text on labels with a specific orientation to the shape of the label. To facilitate application of the labels onto selected surfaces, the labels are often oriented in the same position on the liner. There are generally two accepted copy positions for labels—copy on the bottom of the label dispensing first, or copy on the right side of the label dispensing first. This allows the label to be applied right-side-up and/or to be easily written on with minimal handling of the label once it is removed from the roll of labels.

Depending on the label shape and the print on the label, orienting the labels in a specific manner can result in inefficient spacing of labels, which also results in increased material consumption and waste generation of the substrate.

Thus, there is a demonstrated need for a process of converting labels that produces the highest number of labels on the smallest amount of substrate. Specifically, the more labels produced in a given area, the less material is consumed, and the less waste material is generated.

Further, there is a need to orient the labels in a manner that conforms to the need of a consistent application direction. There is also a need to orient the printing on the labels in a manner that conforms to the need of a consistent application direction.

There is also a need for a triangular shaped label for use in food safety labeling systems that is substantially the same size as current circular or square shaped labels but can be converted using a substantially smaller amount of material.

### SUMMARY OF THE INVENTION

In accordance with the present invention, an adhesive label is produced by a process that includes the steps of providing a web consisting of an adhesive label substrate having a face material, an adhesive layer and a liner. The web is positioned in a label conversion machine wherein the web is continuously pulled through the conversion machine in a preselected web direction. A plurality of triangular shaped labels are configured on the face material in which each label has a first, second and third side wherein the first side of adjacent labels face each other and the second side of adjacent labels face each other such that the third side of each label faces outwardly from the web width. The labels are cut on the web and then printed. The labels are then further processed into individual rolled strips.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an illustration of an embodiment of food safety labels of the subject invention;

FIG. 2 is an illustration of the layers of a pressure sensitive substrate used in the subject invention;

FIG. 3 is an illustration of the prior art configuration of labels;

FIG. 4 is an illustration of the inventive configuration of the subject invention;

FIG. 5A is an illustration of the prior art configuration of various labels;

FIG. 5B is an illustration of the inventive configuration of the subject invention;

FIG. 6A is an illustration of a variable copy position of the subject invention;

FIG. 6B is an illustration of a static copy position of the subject invention;

FIG. 7 is an illustration of an another embodiment of food safety labels of the subject invention; and

FIG. 8 is an illustration of another embodiment of food safety labels of the subject invention.

### DETAILED DESCRIPTION OF THE PREFERRED EMBODIMENTS

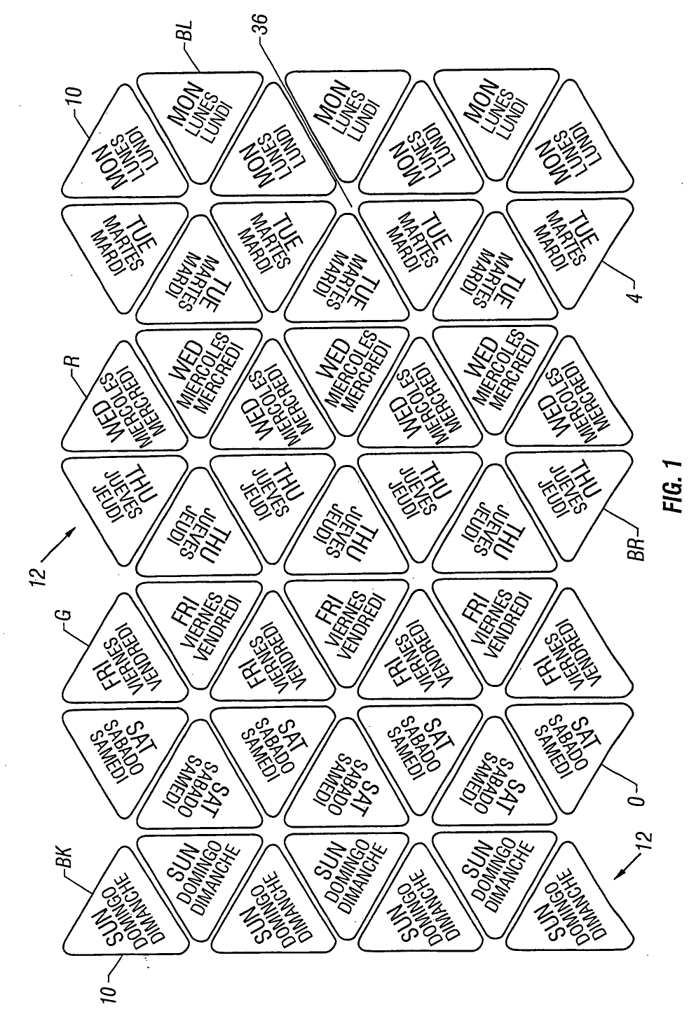

The present invention is directed to triangular shaped labels for use in a food safety labeling system and a configuration system for the production of triangular shaped adhesive or pressure sensitive labels that will minimize the amount of substrate utilized to produce the labels. Referring to FIG. 1, there is shown an illustrative embodiment of triangular shaped labels 10 in strips 12 for use in a food safety labeling system produced by the claimed process.

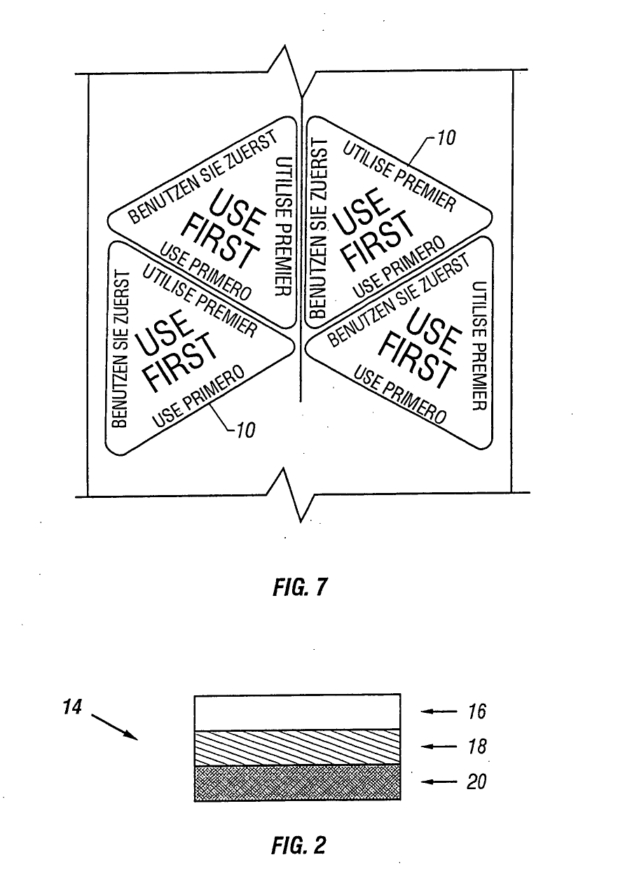

A preferred embodiment of the presently disclosed process utilizes a web 14 which contains a face material 16, an adhesive layer 18, and a liner 20 as shown in FIG. 2. The face material is most commonly paper, but can also be polyester, vinyl, polypropylene or foil. The type of face material selected for a label is determined by the intended use of the label and the desired quality of the printing. There are several types of adhesives applicable for various applications. Examples include permanent, removable, water-soluble, and cold temperature adhesives. The liner is a silicone-coated sheet of paper that allows the face material and applied adhesive to be easily removed from the liner for application to other surfaces.

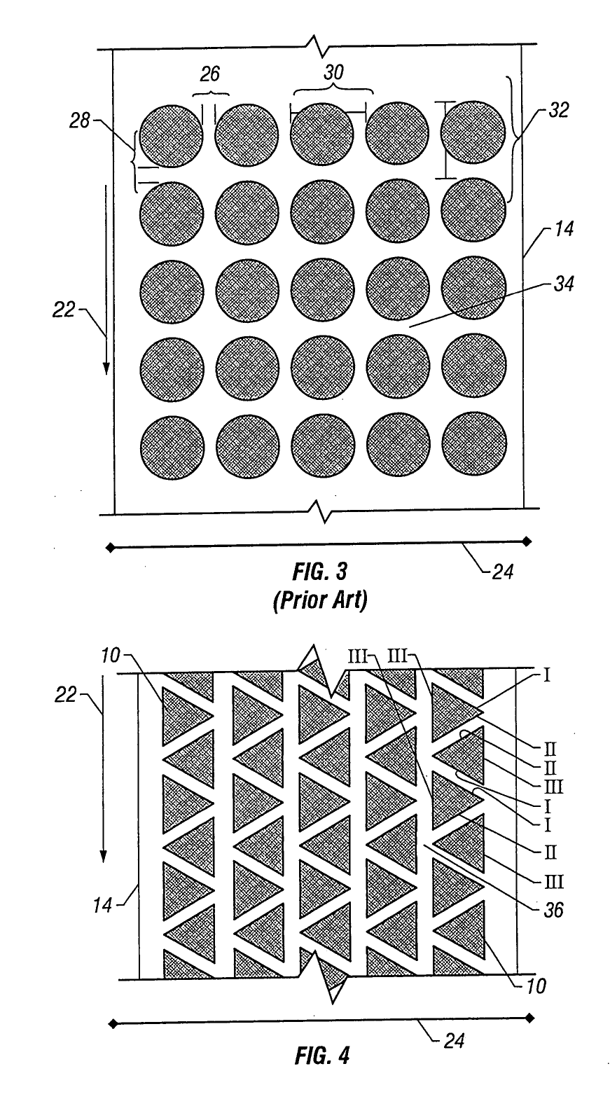

In the conversion process the web 14 is continuously pulled through the conversion machinery (not shown) in one direction called the web direction 22 which is the direction the web 14 is traveling as it passes through the conversion machinery. The total width of the substrate perpendicular to the web direction 22 is called the web width 24. The cutting of the labels 10 is performed according to the placement of the label shapes on the face material 16. In current converting processes for adhesive labels, the configuration of the prior art labels 11 on the face material 16 is illustrated in FIG. 3. The distance between the labels 11 across the web width 24 before they are slit on a rewinder is called Measurement A (26). The distance between the labels 11 going in the web direction 22 is called Measurement B (28). The “repeat across” is the distance from the edge of one label 11 to the same edge on the next label 11 across the web width 24 is called Measurement C (30). The “repeat around” is the distance from one edge of one label 11 to the same edge on the next label 11 going in the web direction 22 is called Measurement D (32). As illustrated in FIG. 3, the distance of Measurements A (26), B (28), C (30) and D (32) is the same which results in a matrix X (34) containing a predetermined amount of substrate waste.

The preferred embodiment of the subject invention utilizes a three sided polygon or triangular shaped label 10 having sides I, II and III of equal distance. In the preferred configuration of the triangular labels 10, the labels 10 are positioned or nested such that sides I of adjacent triangles face each other and sides II of adjacent triangles face each other with sides III of the triangles facing outwardly from the web width 24 (see FIG. 4). The inventive configuration of the triangular shaped labels forms consecutive and adjacent longitudinal rows of triangular shaped labels positioned parallel to the web direction. This nesting configuration results in a matrix Y (36) which contains a substantially smaller amount of substrate waste as compared to matrix X (34) of the prior art.

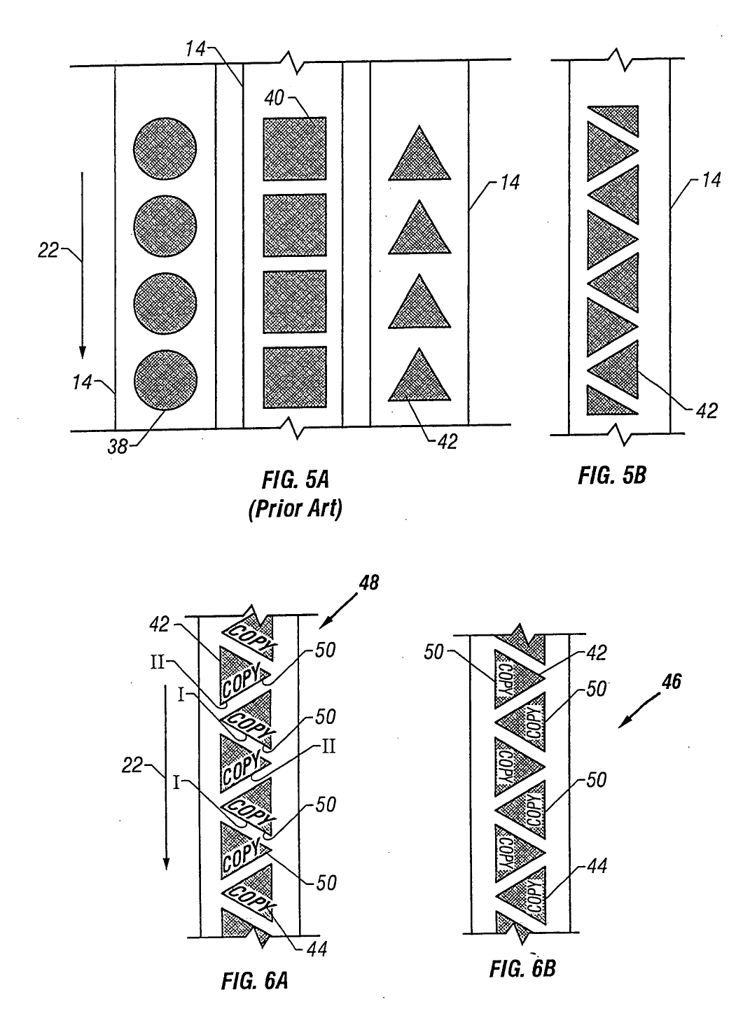

FIG. 5A illustrates a prior art configuration of four labels each of a circular 38, square 40 and triangular 42 shape in which the diameter of the circle 38, the length of one side of the square 40, and the length of one side of the triangle 42 parallel to the web direction 22 is all the same. The inventive configuration is illustrated in FIG. 5B in which the same sized triangular 42 shaped label yields seven labels (counting the two halves) in the same length of web 14 which produces only four of the circular 38, square 40 or triangular 42 shaped labels in the prior art configuration. The distance of the Measurements A, B, C, and D in the inventive configuration has been decreased by the nesting of the triangular 42 shaped labels. The use of the triangular shaped labels 10 with the inventive configuration results in fewer liner feet of substrate required to produce the same number of labels, thus giving a reduction in material without affecting the functionality of the labels.

Adhesive labels generally include text. The position of the text in relation to the web direction 22 is call the “copy position’ 44. The copy position 44 determines how any text will be positioned on a finished roll of labels. Typically labels are oriented on a roll such that the labels can be pulled from the liner with the text being oriented in the same direction. Preferably, the text is oriented on the bottom of the labels. FIGS. 6A and B illustrate alternative copy positions 44 on the bottom 50 of labels 42. A static copy position 46 on the triangular labels 42 would create additional manipulation of the labels 42 in order to apply the labels right side up (FIG. 6B). In order to solve this problem, the configuration process of the subject invention includes a variable copy position 48. In a variable copy position, the text is positioned on alternating sides I and II of adjacent triangular labels 10. By utilizing this variable copy position 48, the bottom 50 of the labels 42 will always be dispensed first, allowing the user to apply the labels with minimal handling (FIG. 6A). FIG. 6 shows a side-by-side illustration of this in which the variable copy position 48 is shown in FIG. 6A and the static copy position 46 is illustrated in FIG. 6B.

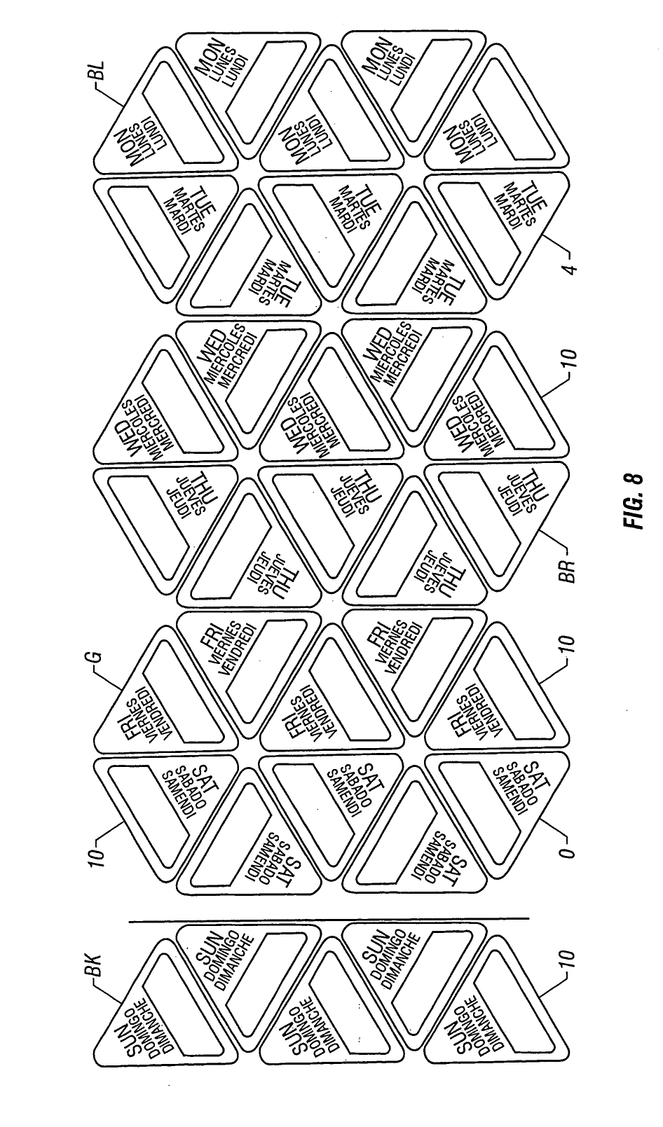

The inventive triangular labels 10 can be made to conform to the three main types of labels used in food safety labeling systems—day of the week FIFO (first in first out) systems, shelf-life/product identification labels and use by/use first labeling. The inventive triangular labels 10 can include the established food safety color code system in which the color blue B is for Monday, yellow Y for Tuesday, red R for Wednesday, brown BR for Thursday, green G for Friday, orange 0 for Saturday, and black BK for Sunday (FIGS. 1 and 8). The triangular labels 10 can also include day-of-the-week text as well as other food rotation text as illustrated in FIGS. 1, 7 and 8. Preferably, the text will be multilingual to include any combinations of English, Spanish, French, Italian or German. Additionally, the inventive labels 10 will utilize face materials and adhesives specifically designed for food rotation and FIFO labeling in the food services industry.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. (canceled).

2. (Canceled).

3. (Canceled).

4. (Canceled).

5. (Canceled).

6. (Canceled).

7. (Canceled).

8. (Canceled).

9. (Canceled).

10. (Canceled).

11. (Canceled).

12. (Canceled).

13. (Canceled).

14. (Canceled).

15. (Canceled).

16. (Canceled).

17. (Canceled).

18. (Canceled).

19. (Canceled).

20. (Canceled).

21. (Canceled).

22. (Canceled).

23. (Canceled).

24. A conversion process for forming triangular shaped labels comprising the steps of:
providing a web consisting of an adhesive label substrate having a face material, an adhesive layer and a liner, the web having a web width and a web direction;
positioning the web in a label conversion machine wherein the web is continuously pulled through the conversion machine in a preselected web direction;
configuring a plurality of triangular shaped labels on the face material in which each label has a first, second and third side wherein the first side of adjacent labels face each other and the second side of adjacent labels face each other such that the third side of each label faces outwardly from the web width;
cutting the plurality of triangular shaped labels on the web;
printing the plurality of triangular labels; and
processing the plurality of triangular labels into individual rolled strips.

25. The conversion process of claim 24, wherein printing the plurality of labels includes printing text on the plurality of labels.

26. The conversion process of claim 24, wherein printing the plurality of labels includes printing color on the labels.

27. The adhesive label of claim 24, wherein the printing on the plurality of labels further includes the step of positioning text on each of the plurality of triangular labels such that the text on each triangular label is oriented in the same direction.

28. The adhesive label of claim 27, wherein a variable copy position for the text results in text being positioned on alternating first and second sides of adjacent triangular labels.
